(19) United States
(12) Patent Application Publication
(10) Pub. No.: US 2010/0175021 A1
(43) Pub. Date: Jul. 8, 2010

(54) Overflow Viewing Window

(75) Inventors: Filomena Ferrara, Rome (IT); Scot MacLellan, Rome (IT); Alessandro Scotti, Rome (IT)

Correspondence Address: IBM CORP. (WIP);c/o WALDER INTELLECTUAL PROPERTY LAW, P.C., 17330 PRESTON ROAD, SUITE 100B, DALLAS, TX, 75252, US

(73) Assignee: International Business Machines Corporation, Armonk, NY (US)

(21) Appl. No.: 12/349,153

(22) Filed: Jan. 6, 2009

(51) Int. Cl. G06F 3/048

(52) U.S. Cl. 715/784

(57) ABSTRACT

A mechanism for viewing a portion of a document that overflows a display portion area of an interface is provided. The document is opened using an application. The document is displayed in a display portion of the interface associated with the application. Portions of the document displayed in the display portion of the interface overflow the width of the display area and are obscured thereby forming obscured portions of the document. A determination is made as to whether a section of the document displayed in the display portion of the interface overflow is selected by a user thereby forming a selected section. Responsive to the selected section being one obscured portion of the obscured portions of the document, a separate display window is opened in which the selected section is displayed in its entirety without changing any viewing parameters associated with the interface.

### BACKGROUND

The present application relates generally to an improved data processing apparatus and method and more specifically to an apparatus and method for viewing portions of document that overflow the viewing area of an interface without changing viewing parameters associated with the interface.

A graphical user interface is one type of program interface that takes advantage of the computer's graphics capabilities to make the program easier to use. Well-designed graphical user interfaces may free a user from learning complex command languages. On the other hand, many users find that they work more effectively with a command-driven interface, especially if they already know the command language.

Graphical user interfaces, such as Microsoft Windows® and the one used by the Apple Macintosh®, feature the following basic components:
Pointer: A symbol that appears on the display screen and that a user moves to select objects and commands. Usually, the pointer appears as a small angled arrow. Text-processing applications, however, use an I-beam pointer that is shaped like a capital I.
Pointing device: A device, such as a mouse or trackball, that enables a user to select objects on the display screen.
Icons: Small pictures that represent commands, files, or windows. By moving the pointer to the icon and pressing a mouse button, a user may execute a command or convert the icon into a window. A user may also move the icons around the display screen as if they were real objects on your desk.
Desktop: The area on the display screen where icons are grouped is often referred to as the desktop because the icons are intended to represent real objects on a real desktop.
Windows: A user may divide the screen into different areas. In each window, a user may run a different program or display a different file. A user may move windows around the display screen, and change their shape and size at will.
Menus: Most graphical user interfaces let a user execute commands by selecting a choice from a menu.

In addition to their visual components, graphical user interfaces also make it easier to move data from one application to another. A true GUI includes standard formats for representing text and graphics. Because the formats are well-defined, different programs that run under a common GUI can share data. This makes it possible, for example, to copy a graph created by a spreadsheet program into a document created by a word processor.

Many DOS programs include some features of GUIs, such as menus, but are not graphics based. Such interfaces are sometimes called graphical character-based user interfaces to distinguish them from true GUIs.

### SUMMARY

In one illustrative embodiment, a method, in a data processing system, is provided for viewing a portion of a document that overflows a display portion area of an interface. The illustrative embodiment opens the document using an application. The illustrative embodiment displays the document in a display portion of the interface associated with the application. In the illustrative embodiment, portions of the document displayed in the display portion of the interface overflow the width of the display area and are obscured thereby forming obscured portions of the document. The illustrative embodiment determines if a section of the document displayed in the display portion of the interface overflow is selected by a user thereby forming a selected section. The illustrative embodiment opens a separate display window in which the selected section is displayed in its entirety without changing any viewing parameters associated with the interface in response to the selected section being one obscured portion of the obscured portions of the document.

In other illustrative embodiments, a computer program product comprising a computer useable or readable medium having a computer readable program is provided. The computer readable program, when executed on a computing device, causes the computing device to perform various ones, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a pictorial representation of an example distributed data processing system in which aspects of the illustrative embodiments may be implemented;

FIG. 2 shows a block diagram of an example data processing system in which aspects of the illustrative embodiments may be implemented;

FIG. 3 depicts a block diagram of an application in accordance with a preferred embodiment of the present invention;

FIG. 4 is a diagram illustrating the display of a window on a display of a data processing system in accordance with an illustrative embodiment;

FIG. 5 is a diagram illustrating an overflow viewing window mechanism used in conjunction with a display of a window on a display of a data processing system in accordance with an illustrative embodiment; and

FIG. 6 depicts the operation of an overflow viewing window mechanism in accordance with an illustrative embodiment.

### DETAILED DESCRIPTION

The illustrative embodiments provide a mechanism for viewing portions of document that overflow the viewing area of an interface without changing viewing parameters associated with the interface. If the content of a document flows past the viewable area of the display in which the document is being viewed, a user may select a portion of the content at which time an overflow viewing window will appear that displays the entire selected portion including the portion originally obscured.

As will be appreciated by one skilled in the art, the present invention may be embodied as a system, method, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, radio frequency (RF), etc.

Computer program code for carrying out operations of the present invention may be written in any combination of one or more programming languages, including an object oriented programming language such as Java™, Smalltalk™, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The illustrative embodiments are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The illustrative embodiments provide for viewing portions of document that overflow the viewing area of an interface without changing viewing parameters associated with the interface. A user may select a portion of content that is obscured by display parameters of an application in which the text is displayed. By selecting the portion of content, an overflow viewing window is revealed to shows the displayed content as well as any obscured content. The user may be able to change the parameters of the overflow viewing window as well as change parameters associated with the display area. If in changing parameters associated with the display the entire width of the content is shown in the display area, then the overflow viewing window automatically closes. Further if the user deselects the selected area or selects another portion of content that is that is obscured by the display parameters of the application, then a new overflow viewing window is revealed.

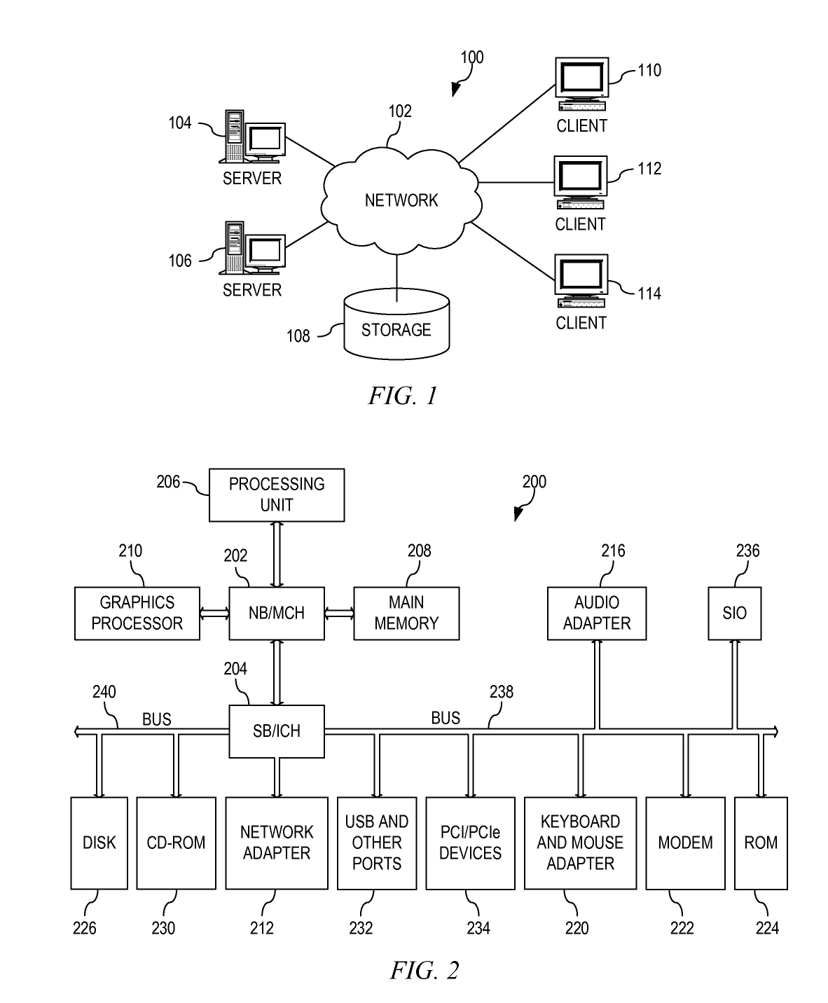

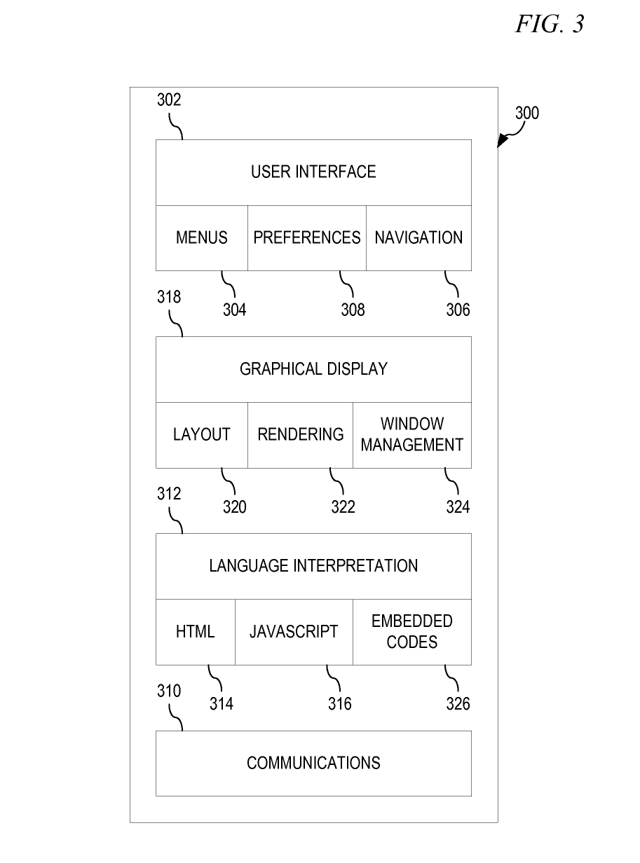

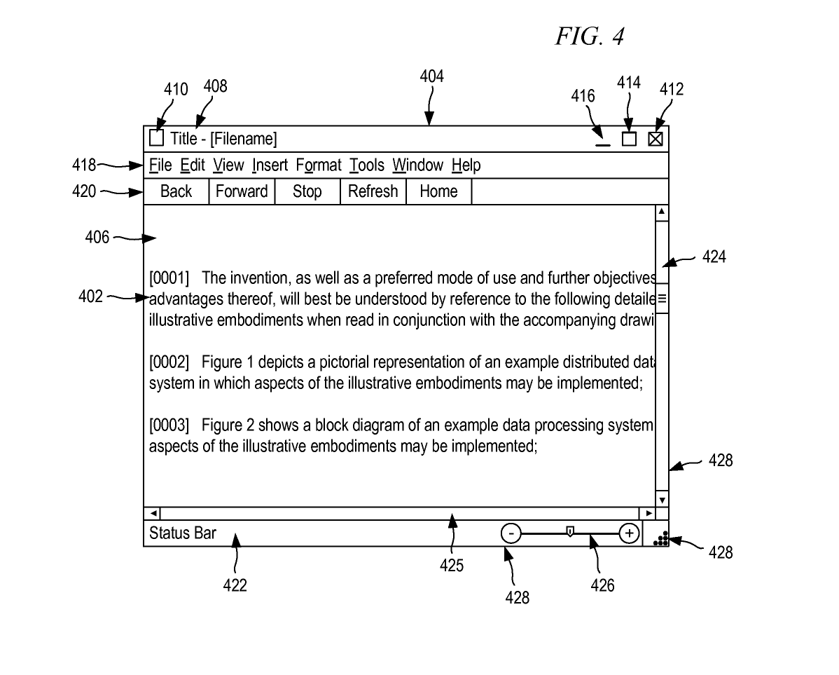

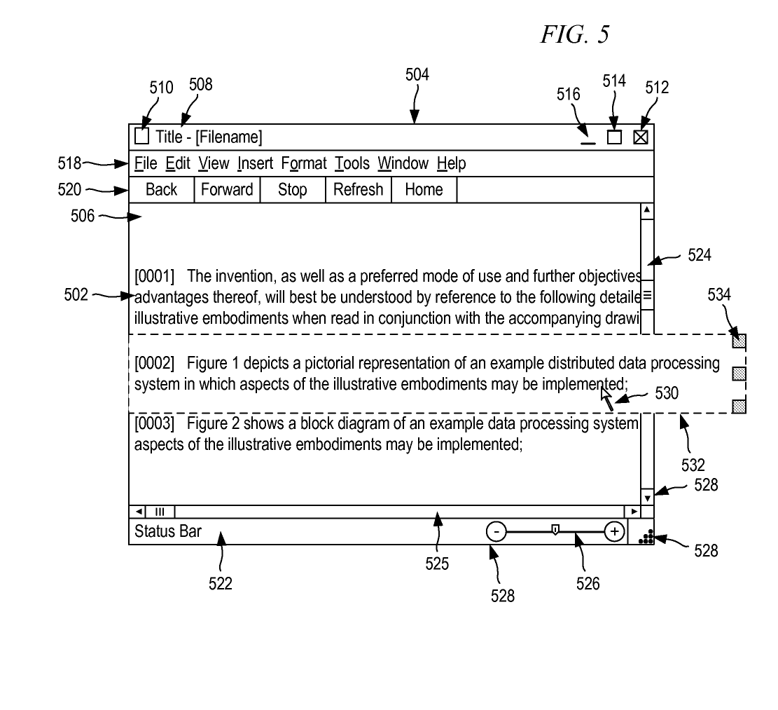

Thus, the illustrative embodiments may be utilized in many different types of data processing environments including a distributed data processing environment, a single data processing device, or the like. In order to provide a context for the description of the specific elements and functionality of the illustrative embodiments, FIGS. 1 and 2 are provided hereafter as example environments in which aspects of the illustrative embodiments may be implemented. While the description following FIGS. 1 and 2 will focus primarily on a single data processing device implementation overflow viewing window mechanism, this is only an example and is not intended to state or imply any limitation with regard to the features of the present invention. To the contrary, the illustrative embodiments are intended to include distributed data processing environments and embodiments in which portions of document that overflow the viewing area of an interface are displayed without changing viewing parameters associated with the interface.

With reference now to the figures and in particular with reference to FIGS. 1-2, example diagrams of data processing environments are provided in which illustrative embodiments of the present invention may be implemented. It should be appreciated that FIGS. 1-2 are only examples and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

With reference now to FIG. 2, a block diagram of an example data processing system is shown in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ System p® computer system, running the Advanced Interactive Executive (AIX®) operating system or the LINUX® operating system (eServer, System p, and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

Turning next to FIG. 3, a block diagram of an application is depicted in accordance with a preferred embodiment of the present invention. An application may be any application that is used to navigate or view information or data in a distributed database.

In this example, application 300 includes a user interface 302, which may be a graphical user interface (GUI) that allows the user to interface or communicate with application 300. User interface 302 provides for selection of various functions through menus 304 and allows for navigation through navigation 306. For example, menu 304 may allow a user to perform various functions, such as saving a file, opening a new window, displaying a history, and entering a URL. Navigation 306 allows for a user to navigate various pages and to select web sites for viewing. For example, navigation 306 may allow a user to see a previous page or a subsequent page relative to the present page. Preferences such as those illustrated in FIG. 3 may be set through preferences 308.

Communications 310 is the mechanism with which application 300 receives documents and other resources from a network, such as the Internet, Intranet, or other network server. Further, communications 310 is used to send or upload documents and resources onto a network. In the depicted example, communication 310 uses HTTP; however, other protocols may be used depending on the implementation. Documents that are received by application 300 are processed by language interpretation 312, which includes HTML unit 314, JavaScript™ unit 316, and embedded codes 326. Language interpretation 312 will process a document for presentation on graphical display 318. In particular, HTML statements are processed by HTML unit 314 for presentation while JavaScript statements are processed by JavaScript unit 316. Language interpretation 312 may also process codes that are embedded within a document using embedded codes 326. Graphical display 318 includes layout unit 320, rendering unit 322, and window management 324. These units are involved in presenting documents to a user based on results from language interpretation 312.

Application 300 is presented as an example of a program in which the present invention may be embodied. Application 300 is not meant to imply architectural limitations to the present invention. Presently available applications may include additional functions not shown or may omit functions shown in application 300.

FIG. 4 is a diagram illustrating the display of a window on a display of a data processing system in accordance with an illustrative embodiment. As shown in FIG. 4, content 402 of a document is retrieved over a computer network in response to a user request is displayed in window 404 that contains multiple interface elements outside of a document display area 406. These interface elements may include title bar 408 comprising program icon 410, “Close” button 412, “Maximize/Restore Down” button 414, and “Minimize” button 416, menu bar 418, tool bar 420, and status bar 422. These interface elements may also include scroll bars 424 and 425 and zoom control 426 which are used to control the viewable portions of document display area 406. Names of exemplary interface elements follow naming conventions used in the many known applications, such as Microsoft® Internet Explorer®, Microsoft® Office®, or the like. Window 404 may also include resizable borders 428.

In the example shown on FIG. 4, content 402 displayed in document display area 406 is wider than the current size of document display area 406, which results in portions of content 402 flowing past the right hand side of document display area 406. In order to view the entire width of content 402, a user may perform any number of operations, such as using scroll bar 425 to scroll the content to the right, maximizing window 404 to the maximum displayable area of the screed on which window 404 is displayed using “Maximize/Restore Down” button 414, resizing window 404 using resizable borders 428, or resizing the viewable size of document display area 406 using zoom control 426. However each of these operations may cause other consequences to occur, such as the beginning of content 402 flowing past the left hand side of document display area 406, maximizing the display causing other windows being obscured, or zooming the viewable size of document display area 406 causing the text or pictures of content 402 to be very small.

FIG. 5 is a diagram illustrating an overflow viewing window mechanism used in conjunction with a display of a window on a display of a data processing system in accordance with an illustrative embodiment. As shown in FIG. 5, content 502 of a document is retrieved over a computer network in response to a user request is displayed in window 504 that contains multiple interface elements outside of a document display area 506. Similar to FIG. 4, the interface elements may include title bar 508 comprising program icon 510, “Close” button 512, “Maximize/Restore Down” button 514, and “Minimize” button 516, menu bar 518, tool bar 520, and status bar 522. These interface elements may also include scroll bars 524 and 525 and zoom control 526 which are used to control the viewable portions of document display area 506. Names of exemplary interface elements follow naming conventions used in the many known applications, such as Microsoft® Internet Explorer®, Microsoft® Office®, or the like. Window 504 may also include resizable borders 528.

In the example shown on FIG. 5, content 502 displayed in document display area 506 is wider than the current size of document display area 506, which results in portions of content 502 flowing past the right hand side of document display area 506. However, in this example, in order to view the entire width of a particular portion of content 502, a user is not required to change viewing parameter options of the application, such as using scroll bar 525 to scroll the content to the right, maximizing window 504 to the maximum displayable area of the screen on which window 504 is displayed using “Maximize/Restore Down” button 514, resizing window 504 using resizable borders 528, or resizing the viewable size of document display area 506 using zoom control 526.

In this illustrative embodiment, even though portions of content 502 flow past the right hand side of document display area 506, the application knows the placement of the content relative to all of content 502 and content elements associated with content 502 in the document. When the application detects that a user has moved cursor 530 over a paragraph of content 502, an overflow viewing window mechanism of the application compares the content of the complete paragraph with the currently displayed content displayed in document display area 506. In this example, if the complete paragraph extends past the right-hand side of document display area 506, then the overflow viewing window mechanism displays overflow viewing window 532. Overflow viewing window 532 is a window that displays then entire text in the paragraph including the section that flows past the right-hand side of document display area 506. While this example illustrates text that is obscured on the right hand side of document display area 506, the illustrative embodiments are not limited to portions of documents that are only obscured on the right-hand side. That is, one of ordinary skill in the art would recognize that the illustrative embodiment may be used with any portions of a document that are obscured whatsoever by a display area of an interface.

Overflow viewing window 532 may be a static window that displays the entire text of the paragraph in a fixed window area, may be a dynamic sizing window that displays the entire text of the paragraph in an automatically-sized area based on the constraints of the display, or may be a dynamic sizing window that the user is able to adjust using window handles 534. While this example illustrates the use of overflow viewing window 532 with respect to a text document, the illustrative embodiments are not limited to only text documents. That is, the processes of the illustrative embodiments may be applied to photos, illustrations, charts, or the like, or any combination of those types of contents, without departing from the spirit and scope of the present invention.

Further, if the user moves cursor 530 to another paragraph of content 502, then the application detects the change of content and performs the operation described above for the new selected paragraph. If the user moves the cursor out of document display area 506 while overflow viewing window 532 is still active, then overflow viewing window 532 remains active. However, if, during the time that overflow viewing window 532 is active, the user changes an application parameter in order to display the entire width of content 502 by utilizing an operation, such as by maximizing window 504 to the maximum displayable area of the interface, resizing window 504 using resizable borders 528, resizing the viewable size of document display area 506 using zoom control 526, or the like, then overflow viewing window 532 would be closed.

Thus, the illustrative embodiments provide a mechanism for viewing portions of document that overflow the viewing area of an interface without changing viewing parameters associated with the interface. If the content of a document flows past the viewable area of the display in which the document is being viewed, a user may select a portion of the content at which time an overflow viewing window will appear that displays the entire selected portion including the portion originally obscured.

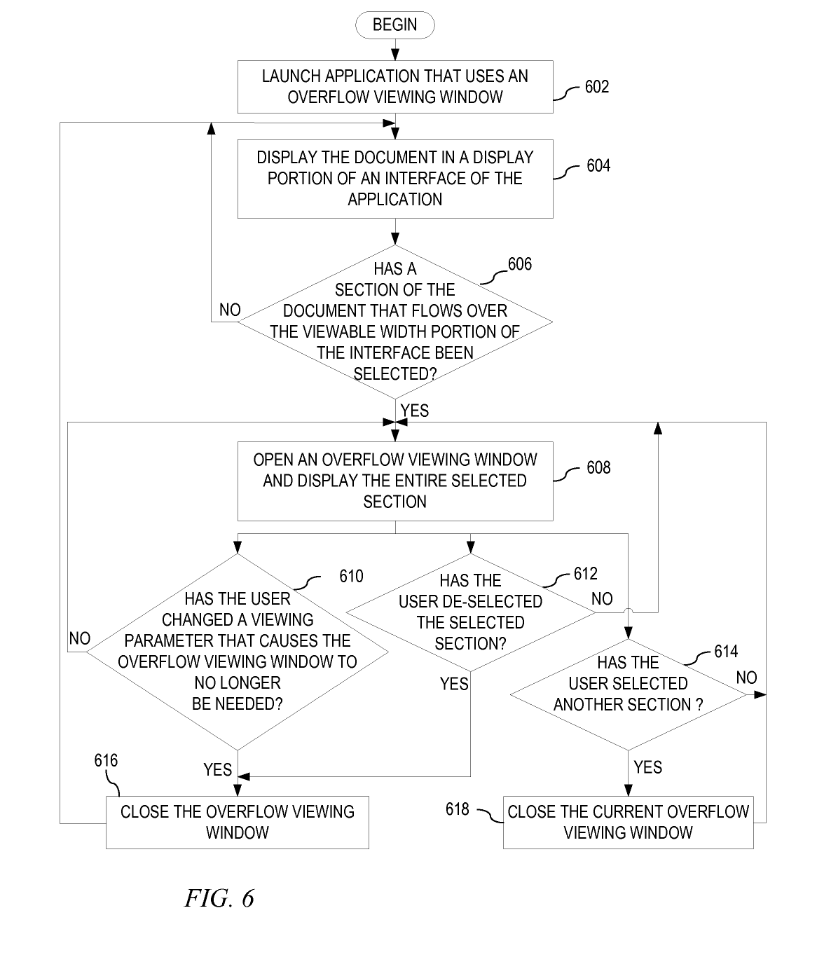

FIG. 6 depicts the operation of an overflow viewing window mechanism in accordance with an illustrative embodiment. As the operation begins, an application is launched that uses an overflow viewing window mechanism (step 602). Once a document has been opened in the interface of the application, the display portion of the interface displays all or a portion of the document (step 604). The overflow viewing window mechanism of the application then determines if the user has selected a section of the document that flows over the viewable width portion of the interface and is thus obscured (step 606). If at step 606, the user has not selected a section of the document that flows over the viewable width portion of the interface, then the operation returns to step 604.

If at step 606 the user selects a section of the document that flows over the viewable width portion of the interface, then the overflow viewing window mechanism opens an overflow viewing window and displays the entire selected section of the document that flows over the viewable width portion of the interface (step 608). Then the overflow viewing window mechanism may either determine if the user has selected a viewing parameter option of the application that causes the overflow viewing window to no longer be needed (step 610), determine if the user has de-selected the selected section of the document (step 612), or if the user has selected another section of the document (step 614). If at step 610 the user has not selected a viewing parameter option that causes the overflow viewing window to no longer be needed, if at step 612 the user has failed to de-select the selected section, or if at step 614 the user has failed to select another portion of the document, then the operation returns to step 608.

If at step 610 the user has selected a viewing parameter option that causes the overflow viewing window to no longer be needed, then the overflow viewing window mechanism closes the overflow viewing window (step 616) with the operation returning to step 604 thereafter. If at step 612 the user de-selects the selected section of the document, then the overflow viewing window mechanism closes the overflow viewing window (step 616) with the operation returning to step 604 thereafter. However, if at step 614 the user selects another section of the document, then the overflow viewing window mechanism closes the current overflow viewing window (step 618) and immediately proceeds to step 608 where a new overflow viewing window is opened and the entire newly selected section of the document that flows over the viewable width portion of the interface is displayed.

Thus, the illustrative embodiments provide for viewing portions of document that overflow the viewing area of an interface without changing viewing parameters associated with the interface. A user may select a portion of content that is obscured by display parameters of an application in which the text is displayed. By selecting the portion of content, an overflow viewing window is revealed to show the displayed content as well as any obscured content. The user may be able to change the parameters of the overflow viewing window as well as change parameters associated with the display area. If in changing parameters associated with the display, the entire width of the content is shown in the display area, then the overflow viewing window automatically closes. Further, if the user deselects the selected area or selects another portion of content that is obscured by the display parameters of the application, then a new overflow viewing window is revealed.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for viewing a portion of a document that overflows a display portion area of an interface, the method comprising:
opening the document using an application;
displaying the document in a display portion of the interface associated with the application, where portions of the document displayed in the display portion of the interface overflow the width of the display area and are obscured thereby forming obscured portions of the document;
determining if a section of the document displayed in the display portion of the interface overflow is selected by a user thereby forming a selected section; and
responsive to the selected section being one obscured portion of the obscured portions of the document, opening a separate display window in which the selected section is displayed in its entirety without changing any viewing parameters associated with the interface.

2. The method of claim 1, further comprising:
determining if the user has changed any of the viewing parameters associated with the interface such that the obscured portions of the document are no longer obscured; and
responsive to the user changing one of the viewing parameters associated with the interface such that the obscured portions of the document are no longer obscured, closing the separate display window.

3. The method of claim 2, wherein the viewing parameters associated with the interface are at least one of maximizing the maximum displayable area of the interface, resizing the display using resizable borders associated with the interface, or resizing the viewable size of the document using a zoom control.

4. The method of claim 1, further comprising:
determining if the user has de-selected the selected section; and
responsive to the user de-selecting the selected section, closing the separate display window.

5. The method of claim 1, further comprising:
determining if the user has selected another section of the document displayed in the display portion of the interface overflow thereby forming a new selected section;
responsive to the user selecting the new selected section, closing the separate display window; and
opening a new separate display window in which the new selected section is displayed in its entirety without changing any of the viewing parameters associated with the interface.

6. The method of claim 1, wherein the separate display window is a static window that displays the selected section in its entirety and wherein the static window has a fixed window area.

7. The method of claim 1, wherein the separate display window is a dynamic sizing window that displays the selected section in its entirety and wherein the dynamic window is an automatically-sized area based on the constraints of a display of the data processing system.

8. The method of claim 1, wherein the separate display window is a dynamic sizing window that displays the selected section in its entirety and wherein the dynamic window is adjusted by the user using window handles associated with the separate display window.

9. A computer program product comprising a computer recordable medium having a computer readable program recorded thereon, wherein the computer readable program, when executed on a computing device, causes the computing device to:
open the document using an application;
display the document in a display portion of the interface associated with the application, where portions of the document displayed in the display portion of the interface overflow the width of the display area and are obscured thereby forming obscured portions of the document;
determine if a section of the document displayed in the display portion of the interface overflow is selected by a user thereby forming a selected section; and
responsive to the selected section being one obscured portion of the obscured portions of the document, open a separate display window in which the selected section is displayed in its entirety without changing any viewing parameters associated with the interface.

10. The computer program product of claim 9, wherein the computer readable program further causes the computing device to:
determine if the user has changed any of the viewing parameters associated with the interface such that the obscured portions of the document are no longer obscured; and
responsive to the user changing one of the viewing parameters associated with the interface such that the obscured portions of the document are no longer obscured, close the separate display window.

11. The computer program product of claim 10, wherein the viewing parameters associated with the interface are at least one of maximizing the maximum displayable area of the interface, resizing the display using resizable borders associated with the interface, or resizing the viewable size of the document using a zoom control.

12. The computer program product of claim 9, wherein the computer readable program further causes the computing device to:
determine if the user has de-selected the selected section; and
responsive to the user de-selecting the selected section, close the separate display window.

13. The computer program product of claim 9, wherein the computer readable program further causes the computing device to:
determine if the user has selected another section of the document displayed in the display portion of the interface overflow thereby forming a new selected section;
responsive to the user selecting the new selected section, close the separate display window; and
open a new separate display window in which the new selected section is displayed in its entirety without changing any of the viewing parameters associated with the interface.

14. The computer program product of claim 9, wherein the separate display window is at least one of a static window that displays the selected section in its entirety and wherein the static window has a fixed window area, a dynamic sizing window that displays the selected section in its entirety and wherein the dynamic window is an automatically-sized area based on the constraints of a display of the data processing system, or a dynamic sizing window that displays the selected section in its entirety and wherein the dynamic window is adjusted by the user using window handles associated with the separate display window.

15. An apparatus, comprising:
a processor; and
a memory coupled to the processor, wherein the memory comprises instructions which, when executed by the processor, cause the processor to:
open the document using an application;
display the document in a display portion of the interface associated with the application, where portions of the document displayed in the display portion of the interface overflow the width of the display area and are obscured thereby forming obscured portions of the document;
determine if a section of the document displayed in the display portion of the interface overflow is selected by a user thereby forming a selected section; and
responsive to the selected section being one obscured portion of the obscured portions of the document, open a separate display window in which the selected section is displayed in its entirety without changing any viewing parameters associated with the interface.

16. The apparatus of claim 15, wherein the instructions further cause the processor to:
determine if the user has changed any of the viewing parameters associated with the interface such that the obscured portions of the document are no longer obscured; and
responsive to the user changing one of the viewing parameters associated with the interface such that the obscured portions of the document are no longer obscured, close the separate display window.

17. The apparatus of claim 16, wherein the viewing parameters associated with the interface are at least one of maximizing the maximum displayable area of the interface, resizing the display using resizable borders associated with the interface, or resizing the viewable size of the document using a zoom control.

18. The apparatus of claim 15, wherein the instructions further cause the processor to:
determine if the user has de-selected the selected section; and
responsive to the user de-selecting the selected section, close the separate display window.

19. The apparatus of claim 15, wherein the instructions further cause the processor to:
determine if the user has selected another section of the document displayed in the display portion of the interface overflow thereby forming a new selected section;
responsive to the user selecting the new selected section, close the separate display window; and
open a new separate display window in which the new selected section is displayed in its entirety without changing any of the viewing parameters associated with the interface.

20. The apparatus of claim 15, wherein the separate display window is at least one of a static window that displays the selected section in its entirety and wherein the static window has a fixed window area, a dynamic sizing window that displays the selected section in its entirety and wherein the dynamic window is an automatically-sized area based on the constraints of a display of the data processing system, or a dynamic sizing window that displays the selected section in its entirety and wherein the dynamic window is adjusted by the user using window handles associated with the separate display window.
